(19) United States
(12) Patent Application Publication
(10) Pub. No.: US 2007/0174504 A1
(43) Pub. Date: Jul. 26, 2007

(54) Method and Apparatus for Advanced Technology Attachment Packet Interface Native Command Queuing

(76) Inventors: Pao-Ching Tseng, Hsinchu County (TW); Ching-Yi Wu, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/306,661

(22) Filed: Jan. 5, 2006

(51) Int. Cl. G06F 13/28

(52) U.S. Cl. 710/22

(57) ABSTRACT

A method involves receiving a first packet having a reference number, the first packet received from a Serial ATA interface that is coupled to a host; sending a first acknowledgement to the host over the Serial ATA interface; receiving a second packet having an ATAPI command from the host over the Serial ATA interface; sending a second acknowledgement to the host over the Serial ATA interface, the second acknowledgement indicating that a bit within said host should be cleared in order to indicate that said Serial ATA interface is no longer busy; sending a data transfer setup packet containing the reference number to the host over the Serial ATA interface; executing the command received from the host in the first packet; and sending a completion packet to the host over the Serial ATA interface for indicating that the command was executed.

### BACKGROUND OF THE INVENTION

The invention relates to a method and a device for implementing Advanced Technology Attachment Packet Interface (ATAPI) Native Command Queuing (NCQ) over a Serial Advanced Technology Attachment (SATA) interface.

The Advanced Technology Attachment (ATA) is an interface specification and is applied to the transmission interface between host systems and storage devices. It is an interface comes with 40 or 80 signal lines in parallel. The ATA specification specifies some feature sets like as Queued feature set. The Queued feature set allows the host to issue concurrent commands to the same device. Some ATA commands are allowed to be queued. These commands include PACKET command (A0h), READ DMA QUEUED command (C7h), READ DMA QUEUED EXT command (26h), WRITE DMA QUEUED command (CCh), WRITE DMA QUEUED EXT command (36h).

Please refer to FIG. 1. FIG. 1 is a timing diagram illustrating Advanced Technology Attachment (ATA) command queuing. In command queuing, an ATA host 120 issues a series of commands to an ATA device 125. The device 125 then determines the most efficient order of executing the commands, and executes the commands in the queue accordingly. In FIG. 1, the host 120 issues a queue command having a command tag=0 in step 130. The device 125 performs a bus release and clearing the busy flag in step 132 to indicate that the device 125 is able to receive additional commands from the host 120. In this example, the host 120 issues two commands to the device 125 for illustrating the ability of the device 125 to perform out-of-order execution. After the busy flag is cleared, the host 120 issues another queue command having a command tag=1 in step 134. The device 125 performs a bus release and clears the busy flag in step 136. In step 138, the device 125 is ready to transfer data and complete the command via SERVICE request. The device 125 sets a service bit (SERV) to 1 to signal the data transfer phase. The host 120 issues a service command in step 140 and looks into the I/O registers and finds out the tag number. In this case, we assume that tag number read from the device is 1 to demonstrate the out of order execution. Next, in step 142, software in the host 120 programs a Direct Memory Access (DMA) engine of the host and point the hardware to a correct data buffer for storing incoming data or transferring data to the device 125. Next, in step 144, Device executes the queued command with tag=1 and begins data transfer, and data is either transmitted from the host 120 to the device 125 or is received by the host 120 from the device 125.

In FIG. 1, steps 130-136 can be thought of as a command phase for entering the commands in the queue of the device 125. Steps 138-144 can be labeled as a data phase for executing data transfer commands. Unfortunately, the data phase has a great deal of overhead that complicates the data transfer process and slows down the transfer of data.

The Serial Advanced Technology Attachment (SATA) standard was introduced in the early 21st century. It is an interface specification initially promoted by the companies of APT, Dell, IBM, Intel, Maxtor, Seagate, etc. The SATA specification is applied to the transmission interface of a hard disk drive or an optical disk drive to replace parallel ATA/ATAPI interface that has been used for a long time. The SATA interface specification specifies two pairs of differential signal lines to replace the original 40 or 80 signal lines connected in parallel. Serializing the original data can reduce the size and voltage, and increase the speed. While serializing the signal line, the SATA specification still keeps most of the concept of ATA specification, such as the definition of I/O registers, command sets, etc. It uses packet to transfer those I/O registers, and payload between the host and the device. Packets are referred as Frame Information Structure (FIS) in the SATA spec. Besides, the SATA specification also introduces some new functions, such as First Party DMA to facilitate the data transfer between the host and the device. In order to distinguish the difference between these two interfaces, parallel Advanced Technology Attachment (PATA) will be used to refer to the traditional parallel 40 or 80 line interface, Serial Advanced Technology Attachment (SATA) will be used to refer to the serialized interface. However, both of the PATA and SATA can carry ATA or ATAPI command sets.

Please refer to FIG. 2. FIG. 2 is a timing diagram illustrating Serial Advanced Technology Attachment (SATA) Native Command Queuing (NCQ). The SATA NCQ protocol is currently applied to hard disk drives for allowing data read and write commands in a queue to be executed out of order. The SATA NCQ protocol is an improvement over the command queuing protocol explained above, and utilizes first party DMA for transferring data. A SATA host 150 sends a Register Frame Information Structure (FIS) 160 having a command with tag=0 to a SATA device 155. The device 155 responds with a Register FIS 162 acknowledging the Register FIS 160 and clearing the busy flag to indicate that the device 155 is able to receive additional commands from the host 150. The host 150 then sends another Register FIS 164 having a command with tag=1, and the device 155 responds with register FIS 166. In this example, it is assumed that both of the commands issued from the host 150 to the device 155 are commands for reading data from the device 155. The steps described above are known as the command phase and the steps described below are known as the data phase of SATA NCQ protocol.

Since the device 155 has received two commands from the host 150, the device 155 must decide which of the two commands to execute first. In this case, the command with tag=1 will be executed before the command with tag=0 for illustrating out-of-order execution. In step 168, the device transmits a DMA Setup FIS for setting up the DMA transfer for the command with tag=1. After the DMA is setup, the data transfer for the command with tag=1 is performed in step 170. These two steps are repeated for the command with tag=0 in steps 172 and 174.

The SATA NCQ protocol is an improvement over the command queuing protocol because the data phase has much less overhead, and the software of the host 150 does not need to manually control data transfer as in the command queuing protocol. With NCQ, first party DMA is used, and the hardware will check the tag number of the command and load the data to the specific buffer corresponding to the tag number. On the other hand, with command queuing, software needs to issue a SERVICE command and specify a buffer to be used for data transfer when the device send an indication to host for transferring data, which increases the complexity and the overhead involved for data transfer.

However, ATAPI device is using different scheme to pass the commands to the device. ATA devices use the I/O registers to pass the commands. The command code is carried by the command register; the parameters are carried by the rest of the registers. For ATAPI device, host put 0xA0 in the command register to indicate ATAPI packet command phase, and then use the data register to pass 12 bytes data (referred as command data block or CDB) for the ATAPI commands. So the current NCQ is only available for hard disk drives (referred to as ATA NCQ in the following), and is not available for devices utilizing the Advanced Technology Attachment Packet Interface (ATAPI) such as optical disk drives like CD-ROM drives and DVD-ROM drives, as well as other devices. Since NCQ is currently unavailable for ATAPI devices, only ATA devices are able to benefit from the advantages that NCQ brings.

### SUMMARY

Methods for performing ATAPI NCQ are provided. An exemplary embodiment of the method includes receiving a Register FIS having a command register set to 0xA0 and a reference number, the FIS received from a Serial ATA interface that is coupled to a host; sending a PIO Setup FIS to the host over the Serial ATA interface; receiving a Data FIS having an ATAPI command data block from the host over the Serial ATA interface; sending a Register FIS to the host over the Serial ATA interface, the Register FIS indicating that a bit within said host should be cleared in order to indicate that said Serial ATA interface is no longer busy; sending a DMA Setup FIS containing the reference number to the host over the Serial ATA interface; executing the command received from the host in the Data FIS; and sending a Set Device Bits FIS to the host over the Serial ATA interface for indicating that the command was executed.

Another exemplary embodiment of the method includes receiving a Register FIS having a command register set to 0xA0 and a reference number, the Register FIS received from a Serial ATA interface that is coupled to a host; sending a PIO Setup FIS to the host over the Serial ATA interface, the PIO Setup FIS indicating that a bit within said host should be cleared in order to indicate that said Serial ATA interface is no longer busy after the following Data FIS is transferred; receiving a Data FIS having an ATAPI command data block from the host over the Serial ATA interface; sending a DMA Setup FIS containing the reference number to the host over the Serial ATA interface; executing the ATAPI command received from the host in the Data FIS; and sending a Set Device Bits FIS to the host over the Serial ATA interface for indicating that the command was executed.

### BRIEF DESCRIPTION OF THE DRAWINGS

FIG. 1 is a timing diagram illustrating ATA command queuing.

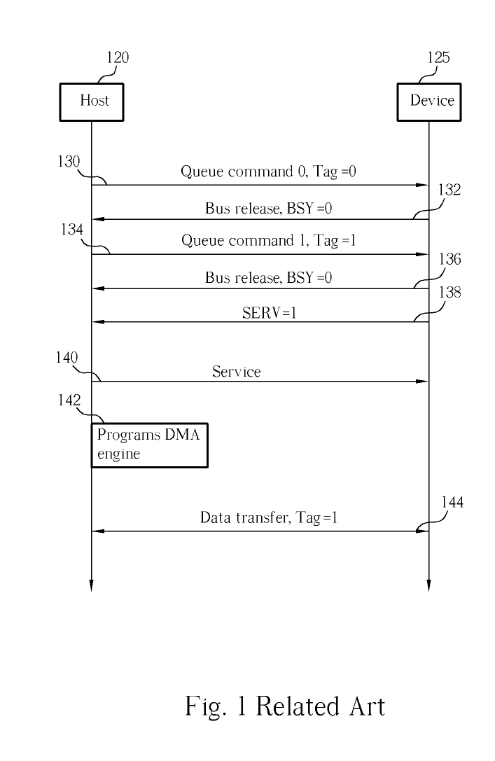

FIG. 2 is a timing diagram illustrating ATA NCQ.

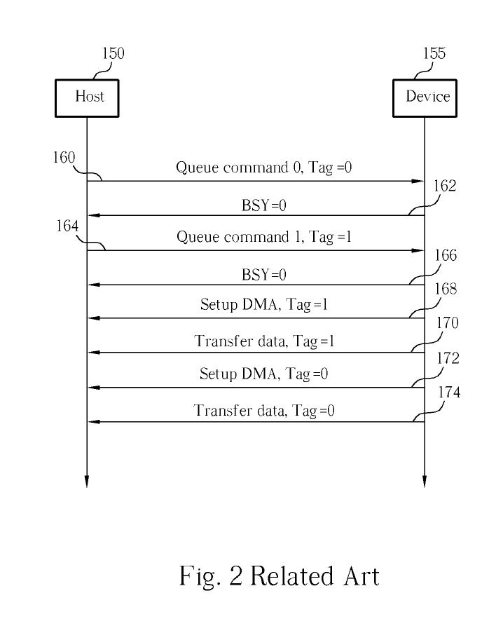

FIG. 3 is a timing diagram illustrating ATAPI NCQ according to a first illustrative embodiment.

FIG. 4 is a timing diagram illustrating ATAPI NCQ according to a second illustrative embodiment.

FIG. 5 is a timing diagram illustrating ATAPI NCQ according to a third illustrative embodiment.

FIG. 6 is a timing diagram illustrating ATAPI NCQ according to a fourth illustrative embodiment.

### DETAILED DESCRIPTION

The following explains a way of implementing Advanced Technology Attachment Packet Interface (ATAPI) Native Command Queuing (NCQ) over a Serial ATA interface. The method makes use of first party DMA for transferring data, but uses commands that are specifically required for the ATAPI standard.

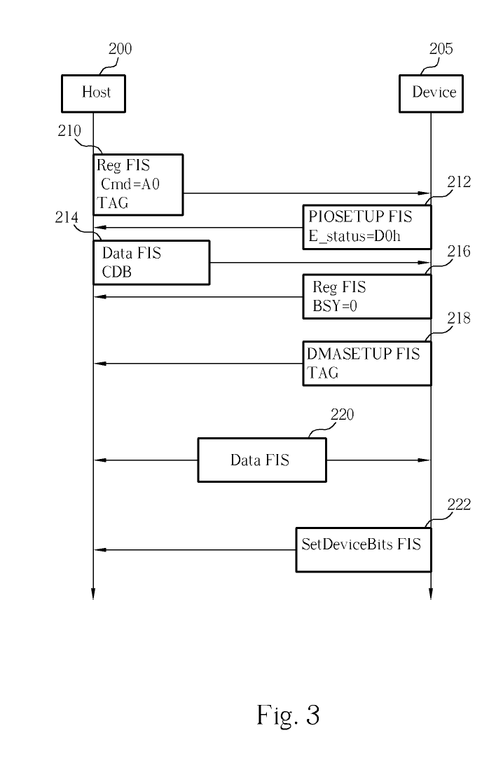

Please refer to FIG. 3. FIG. 3 is a timing diagram illustrating ATAPI NCQ according to a first illustrative embodiment. A SATA host 200 is shown transferring data with a SATA device 205. First of all, the host 200 issues a Register Frame Information Structure (FIS) 210 containing a command register set to 0xA0 and a tag indicating a reference number for the command. The hexadecimal code 0xA0 indicates that 12 bytes data will be transferred from host to device to pass an ATAPI command. The tag is used as a reference number for this particular command so as to distinguish from other commands that the host 200 may issue the device 205. After the device 205 receives the Register FIS 210, the device 205 responds with a PIO Setup FIS 212 having an E_Status of the PIO Setup FIS being set to be 0xD0. Next, the host 200 sends a Data FIS 214 containing a command data block (CDB) to the device 205. The CDB consists of 12 bytes data, and is used to pass the ATAPI command. Then device 205 completes the command phase by transmitting another Register FIS 216 to the host 200 for clearing the busy flag (i.e. setting BSY=0). After the busy flag has been cleared, the device 205 can receive additional commands from the host 200. For simplicity, however, the timing diagram in FIG. 3 only illustrates the execution of a single command since one skilled in the art can easily extend this example to two or more commands being operated on in order or out of order.

The device 205 prepares for the data transmission by issuing a DMA Setup FIS 218 containing the tag to the host 200. The tag indicates which command the data that is about to be transmitted corresponds to. Next, the command received from the host 200 in the Data FIS 214 is executed in one or more Data FIS 220. Depending on if the host 200 is reading data from the device 205 or is writing data to the device 205, the direction of the Data FIS packets 220 will vary accordingly. After the data has been transferred, the device 205 transmits a Set Device Bits FIS 222 to the host 200 for indicating that the command was successfully executed and for releasing the tag number.

In the timing diagram of FIG. 3, four FIS are required in the command phase to perform the communication required for receiving a command from the host 200, communicating with the host 200, and clearing the busy flag. Alternatively, another scenario exists in which only three FIS are required in the command phase.

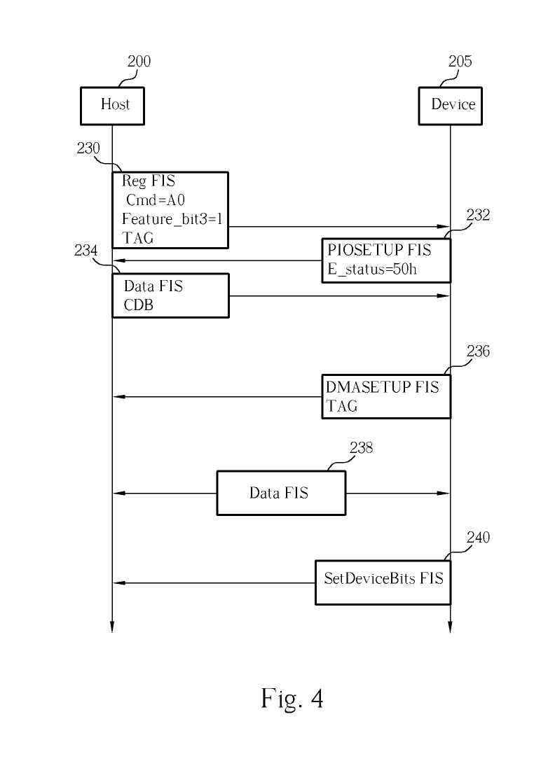

Please refer to FIG. 4. FIG. 4 is a timing diagram illustrating ATAPI NCQ transmitted over a SATA interface according to a second illustrative embodiment. The host 200 issues a Register FIS 230 containing a command register set to 0xA0 and a tag indicating a reference number for the command. The Register FIS 230 contains the hexadecimal code 0xA0 for indicating that 12 bytes data will be transferred from host to device to pass an ATAPI command and also sets Feature_bit3=1 to indicate that this is an NCQ command. After the device 205 receives the Register FIS 230, the device 205 responds with a PIO Setup FIS 232. Unlike the PIO Setup FIS 212 shown in FIG. 3, the PIO Setup FIS 232 has an E_Status set to be 0x50 instead of 0xD0. The effect of this is setting the most significant bit of the status to be equal to 0 instead of 1 allows the PIO Setup FIS 232 to clear the busy flag instead of requiring an extra Register FIS for this purpose. Next, the host 200 sends a Data FIS 234 containing a command data block (CDB) to the device 205. After the busy flag has been cleared with the PIO Setup FIS 232, the device 205 can receive additional commands from the host 200. Thus, the second illustrative embodiment requires only three FIS packets in the command phase since one Register FIS packets is saved by clearing the busy flag with the PIO Setup FIS 232.

As with the first illustrative embodiment shown in FIG. 3, the device 205 prepares for the data transmission by issuing a DMA Setup FIS 236 containing the tag to the host 200. The tag indicates which command the data that is about to be transmitted corresponds to. Next, the command received from the host 200 in the Data FIS 234 is executed in one or more Data FIS packets 238. After the data has been transferred, the device 205 transmits a Set Device Bits FIS 240 to the host 200 for indicating that the command was successfully executed and for releasing the tag number.

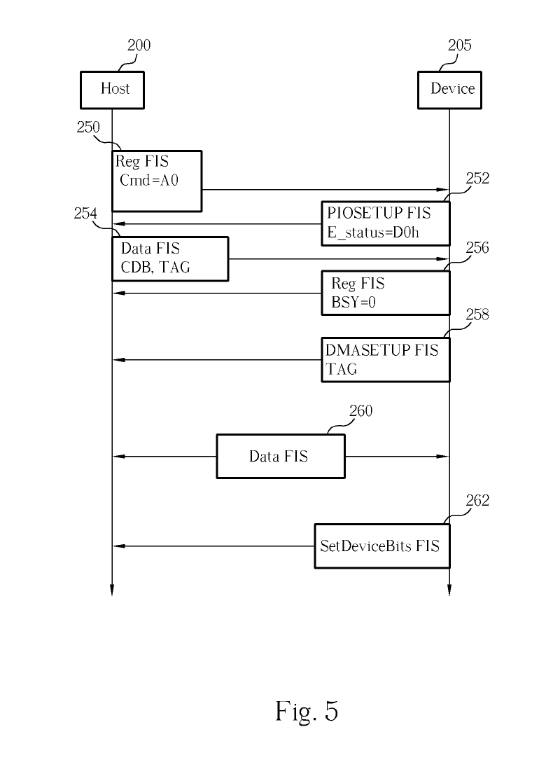

Please refer to FIG. 5. FIG. 5 is a timing diagram illustrating ATAPI NCQ according to a third illustrative embodiment. A SATA host 200 is shown transferring data with a SATA device 205. First of all, the host 200 issues a Register Frame Information Structure (FIS) 250 containing a command register set to 0xA0. After the device 205 receives the Register FIS 250, the device 205 responds with a PIO Setup FIS 252 having an E_Status of the PIO Setup FIS being set to be 0xD0. Next, the host 200 sends a Data FIS 254 containing a command data block (CDB) to the device 205. And the CDB contains a tag number for indexing the queued commands. The device 205 completes the command phase by transmitting another Register FIS 256 to the host 200 for clearing the busy flag (i.e. setting BSY=0). The device 205 prepares for the data transmission by issuing a DMA Setup FIS 258 containing the tag to the host 200. Next, the command received from the host 200 in the Data FIS 254 is executed in one or more Data FIS 260. After the data has been transferred, the device 205 transmits a Set Device Bits FIS 262 to the host 200 for indicating that the command was successfully executed and for releasing the tag number.

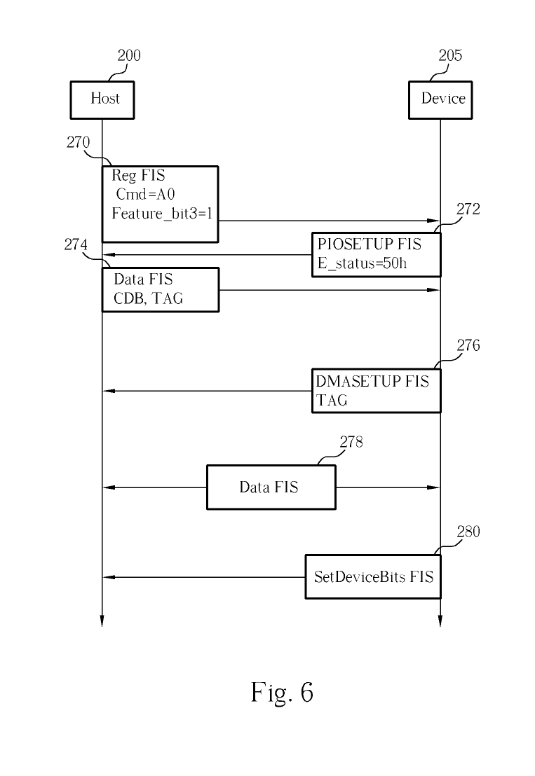

Please refer to FIG. 6. FIG. 6 is a timing diagram illustrating ATAPI NCQ transmitted over a SATA interface according to a forth illustrative embodiment. The host 200 issues a Register FIS 270. The Register FIS 270 contains the hexadecimal code 0xA0 and sets Feature_bit3=1 to indicate that this is an NCQ command. After the device 205 receives the Register FIS 270, the device 205 responds with a PIO Setup FIS 272 with an E_Status set to 0x50. Next, the host 200 sends a Data FIS 274 containing a command data block (CDB) to the device 205. The CDB further contains a tag number for indexing queued commands. Then the device 205 prepares for the data transmission by issuing a DMA Setup FIS 276 containing the tag to the host 200. Next, the command received from the host 200 in the Data FIS 274 is executed in one or more Data FIS packets 278. After the data has been transferred, the device 205 transmits a Set Device Bits FIS 280 to the host 200 for indicating that the command was successfully executed and for releasing the tag number.

In summary, the methods and the device illustrated in the first and second illustrative embodiments allow ATAPI NCQ utilizing first party DMA transfer to be used in SATAdevices such as optical disk drives.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method, comprising:
receiving a first packet having a reference number, the first packet received from a Serial ATA interface that is coupled to a host;
sending a first acknowledgement to the host over the Serial ATA interface;
receiving a second packet having an ATAPI command from the host over the Serial ATA interface;
sending a second acknowledgement to the host over the Serial ATA interface, the second acknowledgement indicating that a bit within said host should be cleared in order to indicate that said Serial ATA interface is no longer busy;
sending a data transfer setup packet containing the reference number to the host over the Serial ATA interface;
executing the data transfer corresponding to the ATAPI command received from the host in the second packet; and
sending a completion packet to the host over the Serial ATA interface for indicating that the command was executed.

2. The method of claim 1, wherein the first packet is a Register Frame Information Structure (Register FIS) containing the reference number, and the command register is set as 0xA0.

3. The method of claim 2, wherein the Register FIS further comprises an indication that the following ATAPI command is a Native Command Queuing (NCQ) command.

4. The method of claim 1, wherein the first acknowledgement is a PIO Setup FIS.

5. The method of claim 3, wherein an E_Status of the PIO Setup FIS is set to be 0xD0.

6. The method of claim 1, wherein the second packet is a Data FIS.

7. The method of claim 1, wherein the second acknowledgement is a Register FIS for clearing a busy flag of the host.

8. The method of claim 1, wherein the data transfer setup packet is a DMA Setup FIS.

9. The method of claim 1, wherein the completion packet is a Set Device Bits FIS.

10. The method of claim 1, wherein the command is a read command using first party DMA for transferring data.

11. The method of claim 1, wherein the command is a write command using first party DMA for transferring data.

12. A method, comprising:
receiving a first packet having a reference number, the first packet received from a Serial ATA interface that is coupled to a host;
sending an acknowledgement to the host over the Serial ATA interface, the acknowledgement indicating that a bit within said host should be cleared in order to indicate that said Serial ATA interface is no longer busy;
receiving a second packet having an ATAPI command from the host over the Serial ATA interface;
sending a data transfer setup packet containing the reference number to the host over the Serial ATA interface;
executing the data transfer corresponding to the ATAPI command received from the host in the first packet; and
sending a completion packet to the host over the Serial ATA interface for indicating that the command was executed.

13. The method of claim 12, wherein the first packet is a Register Frame Information Structure (FIS) containing the reference number, and an indication that the following ATAPI command is a Native Command Queuing (NCQ) command.

14. The method of claim 12, wherein the acknowledgement is a PIO Setup FIS.

15. The method of claim 14, wherein an E_Status of the PIO Setup FIS is set to be 0x50.

16. The method of claim 12, wherein the second packet is a Data FIS.

17. The method of claim 12, wherein the data transfer setup packet is a DMA Setup FIS.

18. The method of claim 12, wherein the completion packet is a Set Device Bits FIS.

19. The method of claim 12, wherein the command is a read command using first party DMA for transferring data.

20. The method of claim 12, wherein the command is a write command using first party DMA for transferring data.

21. A method comprising:
receiving a first packet having an ATAPI command containing a reference number, the packet received from a Serial ATA interface that is coupled to a host;
sending an acknowledgement to said host over said Serial ATA interface, said acknowledgement indicating that a bit within said host should be cleared in order to indicate that said Serial ATA interface is no longer busy;
sending a data transfer setup packet containing the reference number to the host over the Serial ATA interface;
executing the data transfer corresponding to the ATAPI command received from the host in the first packet; and
sending a completion packet to the host over the Serial ATA interface for indicating that the ATAPI command was executed.

22. The method of claim 21, wherein the first packet is a Data FIS containing the 12 bytes ATAPI command.

23. The method of claim 21 wherein said acknowledgement is a Register Frame Information Structure (FIS) for clearing a busy flag of the host.

24. The method of claim 21 wherein said acknowledgement is a PIO Setup FIS, wherein an E_Status of the PIO Setup FIS is set to be 0x50 for clearing a busy flag of the host.

25. The method of claim 21, wherein the data transfer setup packet is a DMA Setup FIS.

26. The method of claim 21, wherein the completion packet is a Set Device Bits FIS.

27. The method of claim 21, wherein the ATAPI command is a read command using first party DMA for transferring data.

28. The method of claim 21, wherein the ATAPI command is a write command using first party DMA for transferring data.
